(19) United States
(12) Patent Application Publication
(10) Pub. No.: US 2015/0193812 A1
(43) Pub. Date: Jul. 9, 2015

(54) INTEGRATION OF PAID AND NATURAL SEARCH DATA

(71) Applicant: Conductor, Inc., New York, NY (US)

(72) Inventor: RAJAN ARORA, Brooklyn, NY (US)

(73) Assignee: CONDUCTOR, INC., New York, NY (US)

(21) Appl. No.: 14/151,379

(22) Filed: Jan. 9, 2014

(51) Int. Cl. G06Q 30/02; G06F 17/30

(52) U.S. Cl. CPC G06Q 30/0242; G06Q 30/0256; G06F 17/30864

(57) ABSTRACT

A system and method effective to generate a search engine report. A first processor may receive a search request and a web property. The first processor may send the search request and the web property to a search engine and receive a result set from the search engine based on the search request and the web property. The first processor may determine natural search engine data based on the result set. The first processor may send the search request and the web property to a second processor and receive paid search engine data based on the search request and the web property. The first processor may generate a report based on the natural search engine data and the paid search engine data.

### BACKGROUND OF THE INVENTION

In a prior art search engine, a crawler aggregates pages from the Internet and ensures that these pages are searchable. The pages retrieved by the crawler are indexed by an indexer. For example, each web page may be broken down into words and respective locations of each word on the page. The pages are then indexed by the words and their respective locations. A user may send a search query to a dispatcher. The dispatcher may forward the query to search nodes. The search nodes search respective parts of the index and return search results along with a document identifier. The dispatcher merges the received results to produce a final result set displayed to a user sorted by ranking scores based on a ranking function. Users may modify web pages in an attempt to have their page appear higher in a result set for particular queries. This disclosure describes an improvement over these prior art technologies.

### SUMMARY OF THE INVENTION

One embodiment of the invention is a method for generating a search engine report. The method may include, by a first processor, receiving a search request and a web property. The method may further include sending the search request and the web property to a search engine. The method may further include receiving a first result set from the search engine based on the search request and the web property. The method may further include determining natural search engine data based on the result set. The method may further include sending the search request and web property to a second processor. The method may further include receiving, from the second processor, paid search engine data based on the search request and based on the web property. The method may further include generating a search engine report based on the natural search engine data and the paid search engine data.

One embodiment of the invention is a device effective to generate a search engine report. The device may include a memory and a first processor configured in communication with the memory. The first processor may be effective to receive a search request and a web property. The first processor may be effective to send the search request and the web property to a search engine. The first processor may be effective to receive a first result set from the search engine based on the search request and the web property. The first processor may be effective to determine natural search engine data based on the first result set. The first processor may be effective to send the search request and the web property to a second processor. The first processor may be effective to receive, from the second processor, paid search engine data based on the search request and the web property. The first processor may be effective to generate a report based on the natural search engine data and the paid search engine data.

One embodiment of the invention is a method for generating a search engine report. The method may include by a first processor, receiving a search request and a web property. The method may include sending the search request and the web property to a search engine. The method may include receiving a first result set from the search engine based on the search request and the web property. The method may include determining natural search engine data based on the first result set. The method may include sending the search request and web property to a second processor. The method may include receiving, from the second processor, paid search engine data based on the search request and based on the web property. The method may include causing the natural search engine data to be displayed in a first column on a display. The method may include causing the paid search engine data to be displayed in a second column on the display different from the first column. The method may include causing a third column including filter fields to be displayed on the display, the filter fields effective to receive a filter selection. The method may include receiving a first filter selection that relates to the natural search engine data. The method may include receiving a second filter selection that relates to the paid search engine data. The method may include generating a filtered search engine report based on the natural search engine data, the paid search engine data, and the first and second filter selections.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 is a system drawing of a system in accordance with an embodiment of the invention.

FIG. 2 is a system drawing of a system in accordance with an embodiment of the invention.

FIG. 3 is a drawing illustrating a user interface in accordance with an embodiment of the invention.

FIG. 4 is a drawing illustrating a user interface in accordance with an embodiment of the invention.

FIG. 5 is a flow diagram illustrating a method which may be performed in accordance with an embodiment of the invention.

### DETAILED DESCRIPTION OF THE PREFERRED EMBODIMENT(S)

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

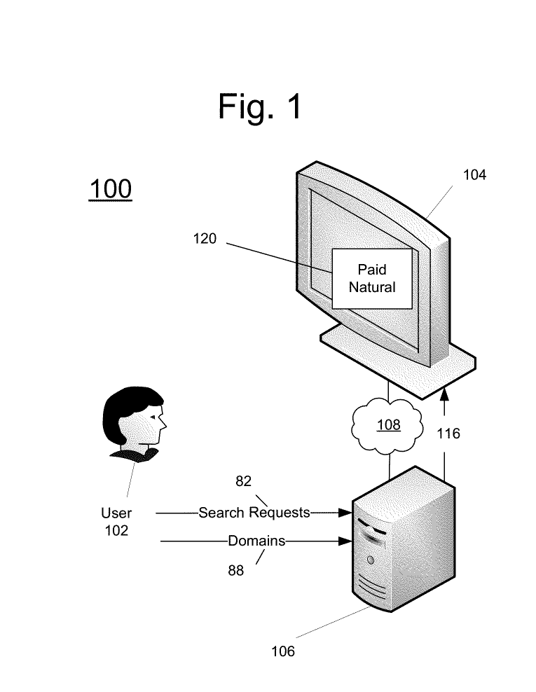

FIG. 1 is a system drawing of a system in accordance with an embodiment of the invention. System 100 may include a display 104 and a processor 106 configured in communication through a network 108. Network 108 could include, for example, the Internet or a Local Area Network (“LAN”). Processor 106 may be in communication with display 104. Display 104 may be configured to display a user interface 120 which may include reports. Reports may include both natural search engine data and paid search engine data as discussed in more detail below.

Processor 106 may receive search requests 82 and/or domains 88 from a user 102. Each search request 82 could be, for example, requests comprising one or more characters, symbols, phrases and/or words. Domains 88 may include web properties. Web properties may include one or more Uniform Resource Locators (“URLs”), web assets such as images and/or videos, and social media accounts and blogs. Processor 106 receives search requests 82 and/or domains 88 and generates report data 116. Report data 116 may include both natural Search Engine Optimization (“SEO”) data and paid SEO data. Natural SEO data may include data indicating ranks of domains 88 for search requests 82 in result sets generated by a search engine. Paid SEO data may include data indicating paid analytics such as ad placement, cost per click, etc. relating to domains 88 for search requests 82. Report data 116 may be displayed as a user interface 120 on a display 104 to user 102 as discussed in more detail below.

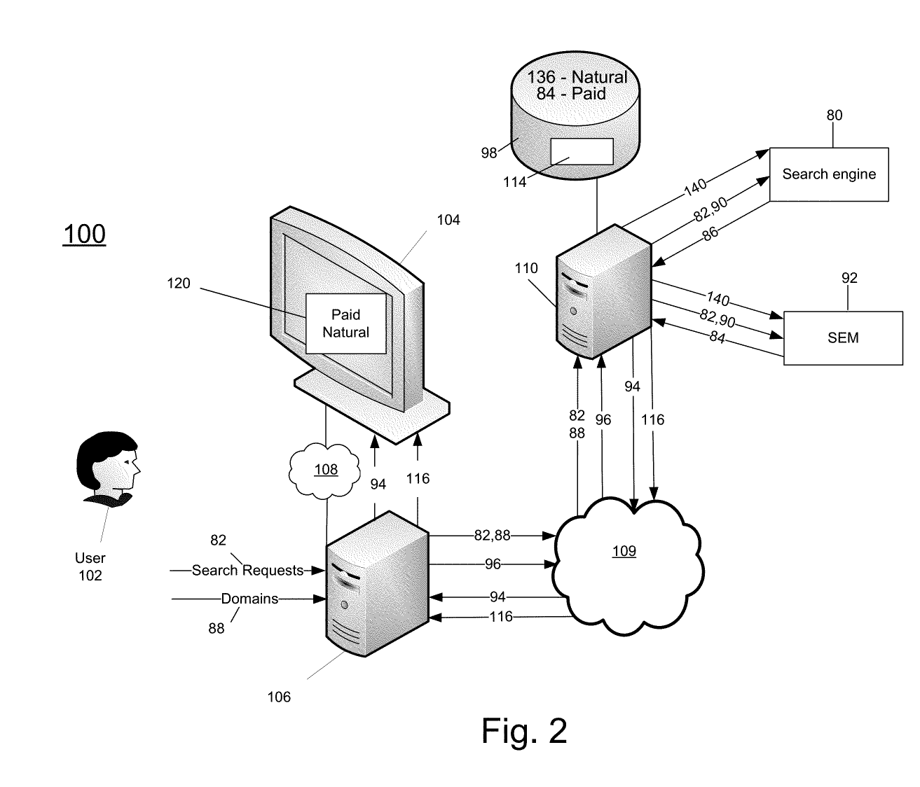

FIG. 2 is a system drawing of a system in accordance with an embodiment of the invention. The system of FIG. 2 is substantially similar to system 100 of FIG. 1, with additional details. Those components in FIG. 2 that are labelled identically to components of FIG. 1 will not be described again for the purposes of clarity.

System 100 may further include a processor 110 in addition to processor 106. Processor 110 may be configured in communication with processor 106 through a network 109. Processor 110 may be in communication with a memory 98 including instructions 114. Network 109 may be the Internet, a wide area network and/or a local area network. Network 109 may or may not be the same network as network 108.

In use, a user 102 may use processor 106 to send one or more search requests 82 and/or domains 88 over network 109 to processor 110. In examples where user 102 sends only a domain 88, and not any search requests 82, processor 110 may identify expanded search requests 90. For example, processor 110 may identify a top threshold number of search requests where domain 88 is ranked above a ranking threshold. In an example, processor 110 may identify the top 50 search requests where domain 88 is ranked above rank 100 for a particular search engine.

Processor 110 may further determine additional URLs 94 related to domains 88 and related to search requests 82 or expanded search requests 90. Processor 110 may send additional URLs 94 to processor 106 so that user 102 may select from among additional URLs 94. Processor 106 may send additional URLs 94 to display 104. User 102 may view additional URLs 94 on display 104 and select selected additional URLs 96. Processor 106 may send selected additional URLs 96 to processor 110 over network 109. Processor 110 may receive selected additional URLs 96 and may combine selected additional URLs 96 with domains 88 to create report URLs 140.

Processor 110 may send search requests 82, or determined search requests 90, and report URLs 140 to a search engine 80 and receive search engine data 86 from search engine 80 in response. Search engine 80 could be, for example, the GOOGLE search engine, the YAHOO! search engine, etc. Search engine data 86 may include a search engine results page (“SERP”). Processor 106, such as by executing instructions 114, may determine natural SEO data 136, based on search engine data 86. As discussed in more detail below, natural SEO data may include search request information, search request ranking, search volume, trend information, and competitor information. Processor 106 may store natural SEO data 136 in memory 98.

Processor 110 may send search requests 82, or determined search requests 90, and report URLs 140 to Search Engine Marketing (“SEM”) processor 92 and receive paid SEO data 84 in response. Paid SEO data 84 may include relevant meta data such as, ad position, cost per click (“CPC”), traffic percent, traffic cost, competitor information including paid positions, trending information, etc. SEM processor 92 may be operated by a search engine marketing company. Paid SEO data 84 may include information obtained by scraping a web site such as GOOGLE. Processor 110 may store paid SEO data 84 in memory 98.

For example, SEM processor 92 may start with a set of seed keywords. The seed keywords may be send to search engines to identify responsive domains. Paid SEO data 84 may indicate domains that are identified for respective keywords.

Processor 110, such as by executing instructions 114, may generate report data 116 based on natural SEO data 136 and paid SEO data 84. Processor 110 may send report data 116 to processor 106 over network 109. Report data 116 may be processed to generate user interface 120 on display 104 such as by processing by processor 106. Processor 106 may be in the same housing as display 104 (such as in a tablet device) or in a different housing as display 104.

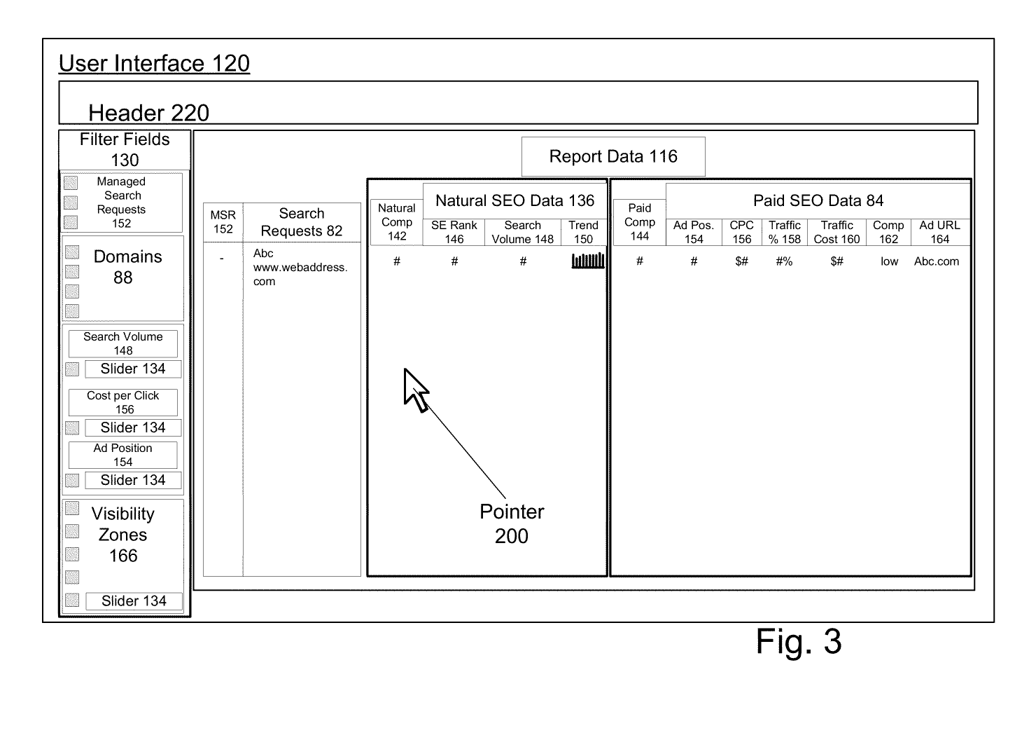

FIG. 3 is a drawing illustrating a user interface in accordance with an embodiment of the invention. User interface 120 may include a header module 220, a column with filter fields 130, a column with managed search requests (MSR) 152, a column with search requests 82, and report data 116.

Header module 220 may include keyword information such as keyword limit, unused keywords, discovered keywords, managed keywords and unmanaged keywords. Managed keywords may be keywords being tracked using natural search engine optimization techniques. Unmanaged keywords may provide information as to a number of keywords not being managed using natural search engine optimization techniques.

Report data 116 may include columns for natural SEO data 136 and paid SEO data 84. Natural SEO data 136 may include columns for natural competitors 142, search engine rank 146, search volume 148 and trend information 150. Natural competitors may identify a number of competitors whose URLs rank above a threshold for search requests 82. Trend information 150 may be displayed as a bar graph with increasingly larger bars indicating an upward trend and decreasingly smaller bars indicating a downward trend. Paid SEO data 84 may include columns for paid competitors 144, ad position 154, cost per click (CPC) 156, traffic percentage 158, traffic cost 160, competition level 162, and the URL that is in the advertisement (URL) 164. Traffic percentage 158 may indicate a percentage of overall paid clicks that go to advertisements in ad position 154.

Search requests 82 may form a first column in user interface 120. Natural SEO data 136 may form a second column in user interface 120. Paid SEO data 84 may form a third column in user interface 120. Search requests 82, natural SEO data 136 and paid SEO data 84 may be displayed side by side to facilitate user comparison. A pointer 200 may be used by users for navigation within the boundaries of user interface 120. Navigation of pointer 200 may be controlled by an input device, such as computer mouse, keyboard or touch screen.

Filter fields 130 may include an interface enabling user 102 to select filters to refine the data to be presented in user interface 120. Filter fields 130 may include an interface enabling user 102 to choose, for example, managed and/or not managed search requests 152, one or more user domains and/or competitor domains 88, search request search volume 148, cost per click 156, ad position 154, and visibility zones 166. Some filter fields 130 may have a user interface slider 134 identifying a range of values for a metric in the filter field. User 102 may position the slider to a desired value or range of values for the metric in the filter field. As explained in more detail below, the position of the slider may result in filtering the natural SEO data 136 and the paid SEO data 84 displayed in report data 116.

As shown, user interface 120 may provide information relating to both paid and natural search data. A user may be able to look at natural information related to a search request and paid information related to the same search request. A user may learn useful information relating to search engine optimization. For example, Ad URL 164 may be different from a URL managed by a user—indicating that paid SEO strategies may be sending traffic to a different URL than natural SEO strategies.

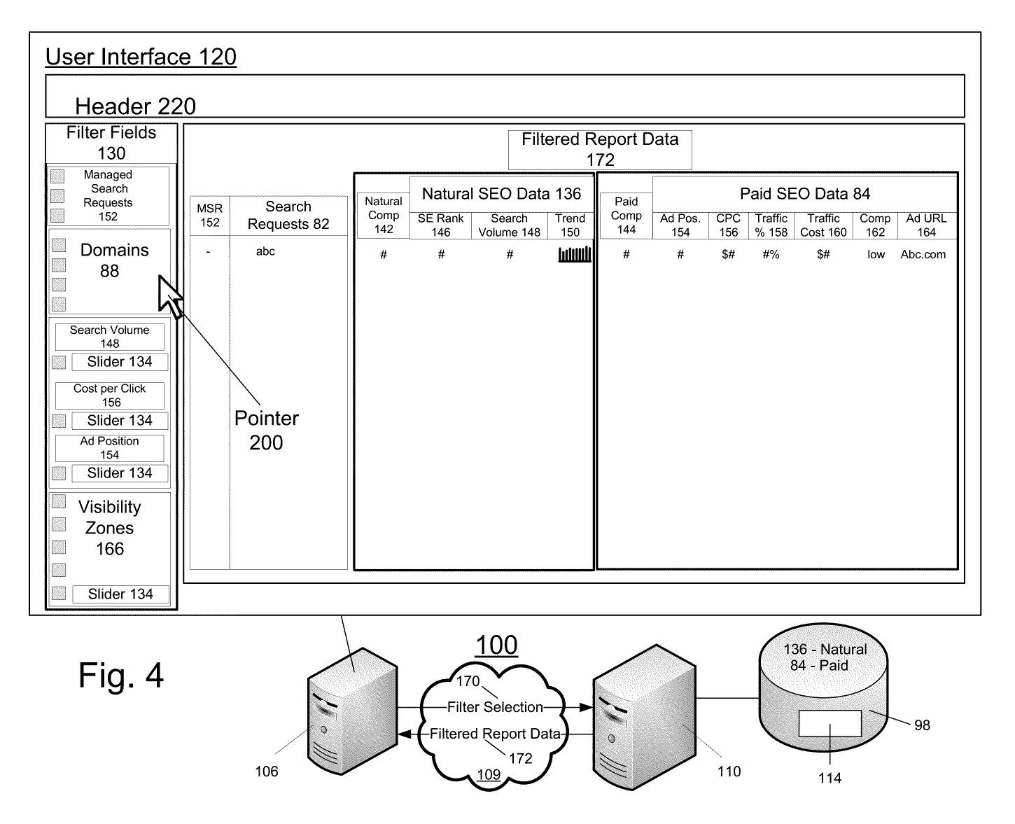

FIG. 4 is a drawing illustrating a user interface in accordance with an embodiment of the invention. The user interface and system 100 of FIG. 4 is substantially similar to the user interface of FIG. 3 and system 100 of FIG. 1-2, with additional details. Those components in FIG. 4 that are labelled identically to components of FIG. 1-3 will not be described again for the purposes of clarity.

In an example, a user may want to determine how two domains are ranking with respect to search requests 82. User 102 may use pointer 200 to select filter selections. For example, user 102 may select two domains in domains 88 section of filter fields 130 in user interface 120. In response to user 102 selecting the domains, processor 106 may send one or more filter selections 170 to processor 110 over network 109. Processor 110 may receive filter selection 170 and, in response, generate filtered search engine report data 172 based on natural SEO data 136 and paid SEO data 84 in memory 98. Filtered search engine report data 172 may be filtered to include only the data relevant to the selected domains. Processor 110 may send filtered report data 172 to processor 106 over network 109. Filtered report data 172 may be displayed on user interface 120 on display 104 to user 102.

User 102 may select filters in filter fields 130 in any combination. In an example, user 102 may want to view only the search requests 82 for selected domains 88 that have selected natural SEO data, such as search volume 148, above a threshold amount. User 102 may use pointer 200 to position slider 134 within search volume 148 section of filter fields 130 to a desired threshold amount. Filter selection 170 may now include the search volume threshold amount in addition to the two selected domains.

Processor 106 may send filter selection 170 to processor 110 over network 109. Processor 110 may receive filter selection 170 and, in response, generate filtered report data 172 from natural SEO data 126 and paid SEO data 84 in memory 98. Filtered report data 172 containing natural SEO data 126 and paid SEO data 84 may be filtered to include only the data relevant to the selected domains that also meet the selected search volume threshold. Processor 110 may send filtered report data 172 to processor 106 over network 109. Filtered report data 172 may be displayed on user interface 120 on display 104 to user 102.

In the example, user 102 may want to further refine filtered report data 172. User 102 may want to view the search requests 82 for the two selected domains that have a search volume 148 above a threshold amount, and a cost per click 156, below a threshold amount. User 102 may again use pointer 200 to position slider 134 within cost per click 156 section of filter fields 130 to a desired threshold amount. Filter selection 170 may now include the cost per click threshold amount in addition to the two selected domains and the search volume threshold amount.

User 102 may select any number of filters in filter field 130. User 102 may also unselect any filters in filter field 130 that were previously selected. In some examples, user 102 may select filter fields 130 so that natural SEO data 136 is displayed for one domain and paid SEO data 84 is displayed for the same domain along with other domains with high keyword overlap. A user may be able to identify keywords being bid on by competitors. Users may filter by ad position such as focusing only on advertisements in a position 1.

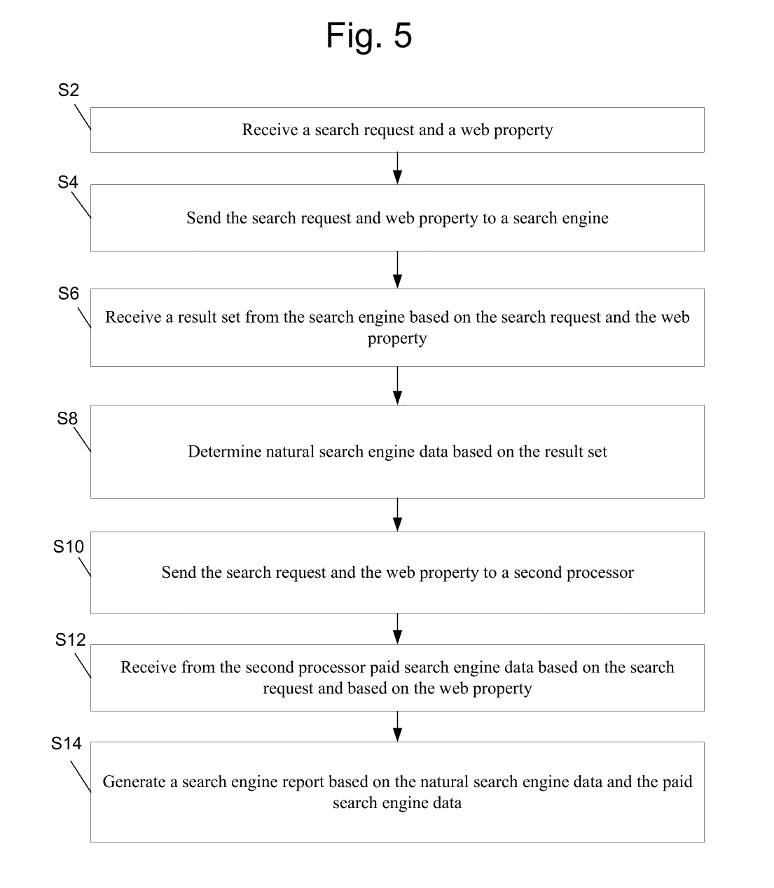

FIG. 5 is a flow diagram illustrating a method which may be performed in accordance with at least some embodiments presented herein. The method in FIG. 5 could be implemented using, for example, system 100 discussed above. The example method may include one or more operations, actions, or functions as illustrated by one or more of blocks S2, S4, S6, S8, S10, S12 and/or S14. Although illustrated as discrete blocks, various blocks may be divided into additional blocks, combined into fewer blocks, or eliminated, depending on the desired implementation.

Processing may begin at block S2 “Receive a search request and a web property.” At block S2, a first processor may receive a search request and a web property from a user.

Processing may continue from block S2 to block S4 “Send the search request and web property to a search engine.” At block S4, the first processor may send the search request and web property to a search engine. The search engine could be the GOOGLE search engine, the YAHOO! search engine, or any other search engine.

Processing may continue from block S4 to block S6 “Receive a result set from the search engine based on the search request and the web property.” At block S6, the first processor may receive a search engine results page (“SERP”) from the search engine.

Processing may continue from block S6 to block S8 “Determine natural search engine data based on the result set.” At block S8, the first processor may determine natural SEO data. Natural SEO data may include search request information, search request ranking, search volume, trend information, and competitor information. The natural SEO data may be stored in a memory.

Processing may continue from block S8 to block S10 “Send the search request and the web property to a second processor.” At block S10, the first processor may send the search request and the domain to a second processor. The second processor may determine paid SEO data based on search engine management software, the search request and the domain. The search engine management software may be operated by a search engine marketing company. Paid SEO data may include relevant metadata about individual search requests and search request performance, pertinent search requests that are bid on in domains, ad position, cost per click (“CPC”), traffic percent, traffic cost, competitor information including paid positions, trending information, etc. Paid SEO data may include information obtained by scraping a web site such as GOOGLE.

Processing may continue from block S10 to block S12 “Receive from the second processor paid search engine data based on the search request and based on the web property.” At block S12, the first processor may receive the paid SEO data from the second processor. The paid SEO data may be stored in the memory along with the natural SEO data.

Processing may continue from block S12 to block S14 “Generate a search engine report based on the natural search engine data and the paid search engine data.” At block S14, the processor may generate a search engine report based on the natural SEO data and the paid SEO data. Report data may be in columns for natural SEO data and paid SEO data. Natural SEO data may include columns for natural competitors, search engine rank, search volume and trend information. Paid SEO data may include columns for paid competitors, ad position, cost per click (“CPC”), traffic percent, traffic cost, competition level, and the URL that is in the advertisement. Search requests, natural SEO data and paid SEO data may be compiled to be displayed in side by side columns to facilitate user comparison.

Among other potential benefits, a system in accordance with the disclosure may provide a marketing professional with guidance as to where to focus search engine optimization efforts. A user may be able to use displayed data to better coordinate paid and natural search optimization efforts. A user may determine that an increase in a certain value in a metric may yield a desired target number of visits in the paid search results, natural search results or both. A user can filter data using one or more natural or paid filters.

For example, many organizations have different individuals or groups working on paid search analytics from the group or individuals working on natural search analytics. A system in accordance with the present disclosure may identify discrepancies between a company's paid search analytics and its natural search analytics. The company may better align paid analytic targets with natural analytic targets so that the two functions work collaboratively rather than independent of each other.

In another example, a marketing professional utilizing a system in accordance with the disclosure may discover a paid analytic target which is already performing as desired as a natural analytic. The marketing professional may determine that the resources for the paid analytic would be better utilized for an analytic that is not performing as well.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for generating a search engine report, the method comprising, by a first processor:
receiving a search request and a web property;
sending the search request and the web property to a search engine;
receiving a first result set from the search engine based on the search request and the web property;
determining natural search engine data based on the result set;
sending the search request and web property to a second processor;
receiving, from the second processor, paid search engine data based on the search request and based on the web property; and
generating a search engine report based on the natural search engine data and the paid search engine data.

2. The method of claim 1, further comprising causing the report to be displayed on a display.

3. The method of claim 2, further comprising:
causing the natural search engine data to be displayed in a first column on the display; and
causing the paid search engine data to be displayed in a second column on the display different from the first column.

4. The method of claim 3, further comprising:
causing a third column including filter fields to be displayed on the display, the filter fields effective to receive a filter selection including an identification of a range of values or a threshold value for a metric that relates to the natural search engine data or the paid search engine data.

5. The method of claim 4, further comprising causing the search request to be displayed in a fourth column on the display.

6. The method of claim 4, wherein the filter fields include, managed search requests, user and competitor domains, search volume, cost per click, ad position, and/or visibility zones.

7. The method of claim 3, further comprising
receiving a first filter selection that relates to the natural search engine data;
receiving a second filter selection that relates to the paid search engine data; and
generating a filtered search engine report based on the natural search engine data, the paid search engine data, and the first and second filter selections.

8. A device effective to generate a search engine report, the device comprising:
a memory;
a first processor configured in communication with the memory, the first processor effective to:
receive a search request and a web property;
send the search request and the web property to a search engine;
receive a first result set from the search engine based on the search request and the web property;
determine natural search engine data based on the first result set;
send the search request and the web property to a second processor;
receive, from the second processor, paid search engine data based on the search request and the web property; and
generate a report based on the natural search engine data and the paid search engine data.

9. The device of claim 8, wherein the first processor is further effective to cause the report to display on a display.

10. The device of claim 9, wherein the first processor is further effective to:
cause the natural search engine data to be displayed in a first column on the display; and
cause the paid search engine data to be displayed in a second column on the display different from the first column.

11. The device of claim 10, wherein the report includes a third column on the display, the third column comprising filter fields on the display, the filter fields effective to receive a filter selection including an identification of a range of values or a threshold value for a metric.

12. The device of claim 11, wherein the filter fields include, managed search requests, user and competitor domains, search request search volume, cost per click, ad position, and visibility zones.

13. The device of claim 12, wherein the filter fields include an interactive slider that can be positioned to a desired value or range of values for the metric.

14. The device of claim 10, wherein the first processor is effective to:
receive a first filter selection that relates to the natural search engine data;
receive a second filter selection that relates to the paid search engine data; and
generate a filtered search engine report based on the natural search engine data, the paid search engine data, and the first and second filter selections.

15. A method for generating a search engine report, the method comprising, by a first processor:
receiving a search request and a web property;
sending the search request and the web property to a search engine;
receiving a result set from the search engine based on the search request and the web property;
determining natural search engine data based on the result set;
sending the search request and web property to a second processor;
receiving, from the second processor, paid search engine data based on the search request and based on the web property;
causing the natural search engine data to be displayed in a first column on a display;
causing the paid search engine data to be displayed in a second column on the display different from the first column;
causing a third column including filter fields to be displayed on the display, the filter fields effective to receive a filter selection;
receiving a first filter selection that relates to the natural search engine data;
receiving a second filter selection that relates to the paid search engine data; and
generating a filtered search engine report based on the natural search engine data, the paid search engine data, and the first and second filter selections.

16. The method of claim 15, further comprising causing the filtered search engine report to be displayed on a display.

17. The method of claim 15, wherein:
the web property is a first web property;
the result set is a first result set;
the natural search engine data is first natural search engine data; and
the method further comprises:
receiving a second web property different from the first web property;
sending the second web property and the search request to the search engine;
receiving a second result set from the search engine;
determining second natural search engine data based on the second result set; and
generating a modified search engine report based on the second natural search engine data and the paid search engine data.

18. The method of claim 15, wherein the filter fields include, managed search requests, user and competitor domains, search volume, cost per click, ad position, and/or visibility zones.

19. The method of claim 15, wherein the natural search data includes search request information, search request ranking, search volume, trend information, and/or competitor information.

20. The method of claim 15, wherein the paid search data includes ad position, cost per click, traffic percent, traffic cost, competitor information including paid positions, and/or trending information.
